(19) United States
(12) Patent Application Publication
(10) Pub. No.: US 2012/0161080 A1
(43) Pub. Date: Jun. 28, 2012

(54) CONDUCTIVE POLYMER COMPOSITION AND CONDUCTIVE FILM USING THE SAME

(75) Inventors: Yong Hyun Jin, Seoul (KR); Youn Soo Kim, Seoul (KR); Sang Hwa Kim, Gyunggi-do (KR)

(73) Assignee: SAMSUNG ELECTRO-MECHANICS CO., LTD., Gyunggi-do (KR)

(21) Appl. No.: 13/042,285

(22) Filed: Mar. 7, 2011

(30) Foreign Application Priority Data
Dec. 27, 2010 (KR) 102010135686

(51) Int. Cl. H01B 1/12

(52) U.S. Cl. 252/500

(57) ABSTRACT

Disclosed herein are a conductive polymer composition and a conductive film using the same. The conductive polymer composition includes: a conductive polymer; a solvent; and an ionic binder. A transparent parent is formed by adding the ionic binder to the conductive polymer, thereby making it possible to have excellent flexibility and a low sheet resistance of 110Ω/□ to 500Ω/□ and simplify a coating process of the transparent electrode. Accordingly, the transparent electrode of the present invention is suitable for being used as a display device.

### CROSS REFERENCE TO RELATED APPLICATION

This application claims the benefit of Korean Patent Application No. 10-2010-0135686, filed on Dec. 27, 2010, entitled “Conductive Polymer Composition and Conductive Film Using the Same” which is hereby incorporated by reference in its entirety into this application.

### BACKGROUND OF THE INVENTION

1. Technical Field

The present invention relates to a conductive polymer composition and a conductive film using the same.

2. Description of the Related Art

Due to digitalization and rapid high performance of various electronic appliances and communication devices including computers, the realization of a portable display device has been urgently required. In order to realize the portable display device, a material used for electrodes for the display device should have a transparency property and a low resistance value, as well as high flexibility to cope with mechanical impact. In addition, even when the appliances or the devices are overheated or exposed to high temperature, there should be no occurrence of short circuits or have minimal variance in sheet resistance.

Presently, a material for a transparent electrode, which is the most widely used for the display device, is indium tin oxide (ITO). However, a process of forming the transparent electrodes of ITO has disadvantages in that high costs are required and large area display devices are difficult to be realized. In particular, a process of coating ITO in a large area has fatal disadvantages in that the brightness of display devices is reduced and the efficiency of light emission is lowered due to a large variation in sheet resistance. Further, indium, the main raw material of ITO, is a limited mineral, and is being rapidly exhausted with expansion of the display device market.

In order to overcome these disadvantages of ITO, a study is being conducted that the transparent electrode is formed of a conductive polymer capable of achieving excellent flexibility and simplifying a coating process. However, in a case where the transparent electrode is formed of the conductive polymer, a sheet resistance of the transparent electrode is significantly increased to a level of 10⁵˜10⁹Ω/□. As such, the conductive polymer is difficult to be used in the transparent electrode for the display device. Therefore, a proposal is suggested that dimethylsufoxide (DMSO), ethylene glycol, sorbitol, or the like is added to the conductive polymer in order to lower the sheet resistance of the transparent electrode formed of the conductive polymer. However, the conductive polymer is still inadequate to use for the transparent electrode for the display device. Besides, the sheet resistance of the transparent electrode is further increased due to binders used for coating the conductive polymer.

### SUMMARY OF THE INVENTION

The present invention has been made in an effort to provide a conductive polymer composition capable of improving a sheet resistance of a transparent electrode by adding ionic binders.

Further, the present invention has been made in an effort to provide a conductive film using the conductive polymer composition.

According to a preferred embodiment of the present invention, there is provided a conductive polymer composition including: a conductive polymer; a solvent; and an ionic binder.

The conductive polymer composition may include 15 wt % to 70 wt % of the conductive polymer, 20 wt % to 75 wt % of the solvent, and 0.001 wt % to 20 wt % of the ionic binder.

The conductive polymer may be poly-3,4-ethylenedioxythiophene/poly(stylenesulfonate) (PEDOT/PSS).

The solvent may be any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof.

The ionic binder may be ionic polyacrylic.

The ionic binder may be ionic carbonate type polyurethane.

The conductive polymer composition may further include one or more additives selected from a group consisting of a second dopant and a dispersion stabilizer.

The second dopant may be at least one polar solvent selected from a group consisting of dimethylsulfoxide, N-methylpyrrolidone, N,N-dimethylformamide and N-dimethylacetimide.

The dispersion stabilizer may be ethylene glycol or sorbitol.

According to another preferred embodiment of the present invention, there is provided a conductive film including: a base member; and a transparent electrode formed by coating and drying a conductive polymer composition on the base member, the conductive polymer composition including a conductive polymer, a solvent, and an ionic binder.

The conductive polymer may be poly-3,4-ethylenedioxythiophene/polystylenesulfonate (PEDOT/PSS).

The solvent may be any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof.

The ionic binder may be ionic polyacrylic.

The ionic binder may be ionic carbonate type polyurethane.

The conductive polymer composition may further include one or more additives selected from a group consisting of a second dopant and a dispersion stabilizer.

The second dopant may be at least one polar solvent selected from a group consisting of dimethylsulfoxide, N-methylpyrrolidone, N,N-dimethylformamide and N-dimethylacetimide.

The dispersion stabilizer may be ethylene glycol or sorbitol.

The transparent electrode may have a sheet resistance of 110Ω/□ to 500Ω/□.

The conductive polymer composition may be coated on the base member by screen printing, gravure printing, or inkjet printing.

### BRIEF DESCRIPTION OF THE DRAWINGS

FIG. 1 is a view showing a state in which counter ions are separated from a polymeric ion by dissociation of an ionic binder to be stretched in a straight line or swelled;

FIG. 2 is a view showing a procedure in which a polymeric ion is tangled or stretched to reach an equilibrium state;

FIG. 3 is a graph showing electrical conductivity of a transparent electrode measured according to the content of ionic binder; and

FIG. 4 is a graph showing a sheet resistance of a transparent electrode measured according to the content of ionic binder.

### DESCRIPTION OF THE PREFERRED EMBODIMENTS

Various objects, advantages and features of the present invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Hereinafter, preferred embodiments according to the present invention will be described in detail with reference to the accompanying drawings.

Conductive Polymer Composition

A conductive polymer composition according to the present invention includes a conductive polymer, a solvent and an ionic binder.

The conductive polymer is a polymer being electrically conductive, which has one π-electron per one carbon atom, and, generally, has a molecular weight of approximately 10,000 or more. Herein, the conductive polymer has an advantage in that a thin film having both a light weight and high flexibility is obtainable, in comparison with the existing ITO (indium tin oxide). The conductive polymer may be one of polythiophenes, polypyrroles, polyphenylenes, polyanilines, or polyacetylenes, and preferably, poly-3,4-ethylenedioxythiophene/polystylenesulfonate (hereinafter, referred to as “PEDOT/PSS”) of the polythiophenes. Herein, the PEDOT/PSS is water soluble by doping polystylenesulfonate (PSS) as a first dopant therein. In addition, the PEDOT/PSS has very excellent thermal stability.

Meanwhile, when the conductive polymer is less than 15 wt % of the conductive polymer composition, the transparent electrode formed of the conductive polymer composition is difficult to realize a sheet resistance of 1000Ω/□ or less. When the conductive polymer is more than 70 wt % of the conductive polymer composition, coating workability is deteriorated. Accordingly, the content of the conductive polymer is, preferably, 15 wt % to 70 wt % of the conductive polymer composition.

The solvent is used as a dispersion of the conductive polymer composition, and one or more kinds of solvent may be used. For example, the solvent may be any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof. When the solvent is less than 20 wt % of the conductive polymer composition, the dispersibility of the conductive polymer composition is deteriorated. When the solvent is more than 75 wt % of the conductive polymer composition, the electrical conductivity of the conductive polymer composition is deteriorated. Therefore, the content of the solvent is, preferably, 20 wt % to 75 wt % of the conductive polymer composition.

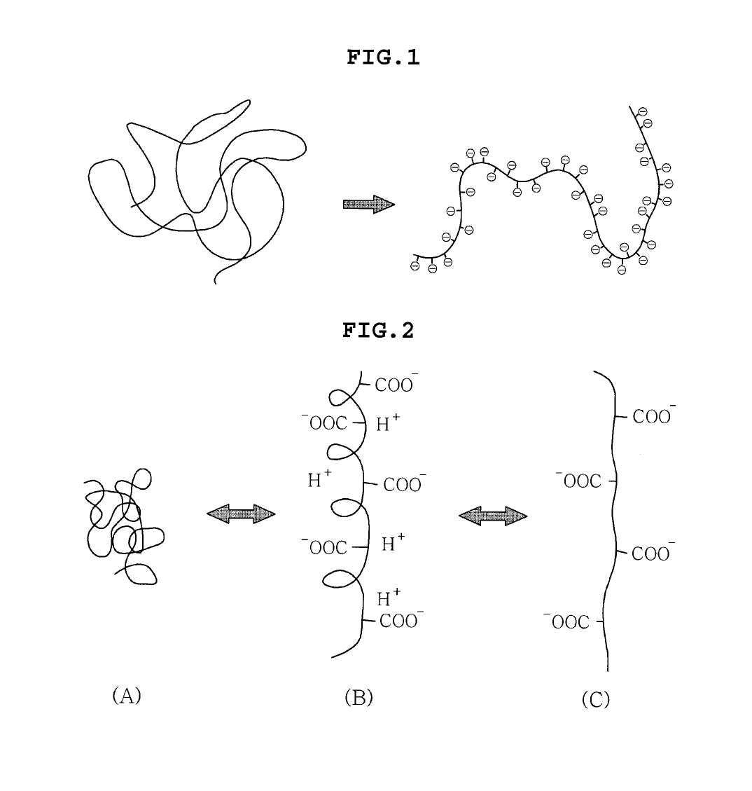

The ionic binder performs a role of increasing an adhesive strength at the time of coating the conductive polymer composition, as well as performs a role of decreasing a sheet resistance of a transparent electrode to be coated due to an ionic character thereof. Herein, the ionic binder has a plurality of dissociation groups connected to a chain. Therefore, when the ionic binder is dissolved in the water, counter ions are separated from a polymeric ion by dissociation of the ionic binder. As shown in FIG. 1, when the counter ions are separated by dissociation of the ionic binder, the polymeric ion is stretched in a straight line or maintained in a swelled state due to strong electrostatic repulsive force between homogeneous ions thereof. Accordingly, the number of effective charges in the polymeric ion is increased. Therefore, when this polymeric ion is immobilized within a transparent electrode formed by coating, the charges are easy to move, and thereby lower the sheet resistance of the transparent electrode. On the contrary, when the number of effective charges in the polymeric ion is increased, the counter ions may be pulled and fixed to the polymeric ion by electric attractive force between the polymeric ion and the counter ions. Accordingly, the number of effective charges in the polymeric ion is reduced to weaken the electrostatic repulsive force between the homogeneous ions, and thereby the polymeric ion becomes tangled. As a result, as shown in FIG. 2, the polymeric ion is tangled ((A) of FIG. 2), or stretched ((C) of FIG. 2). The polymeric ion swings between the two counter states, and then reaches an equilibrium state (B of FIG. 2). That is, sections in which the effective charges are optimized by the kind, the content, and the like of the ionic binder are generated in polymeric ion, and thereby, the transparent electrode expresses the optimum sheet resistance through the sections. In particular, the optimum sheet resistance of a transparent electrode for a display device is 110Ω/□ to 500Ω/□. In order to realize this, the content of the ionic binder is, preferably, 0.001 wt % to 20 wt % of the conductive polymer composition.

Meanwhile, it is preferable to use ionic polyacrylic for the ionic binder. Like the following reaction equation, when the ionic polyacrylic is dissolved in the water, a counter ion, H₃O⁺, is separated by dissociation of the ionic polyacrylic to increase the electrostatic repulsive force between homogeneous ions. As a result, the ionic polyacrylic is stretched in a straight line or maintained in a swelled state.

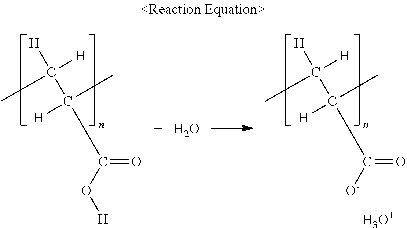

Also, ionic carbonate type polyurethane having the following chemical formula, besides the above described ionic polyacrylic, may be used as the ionic binder.

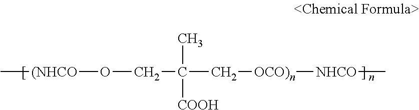

The ionic carbonate type polyurethane also includes a carboxyl group (—COOH), like the ionic poly acryl. Accordingly, when the ionic carbonate type polyurethane is dissolved in the water, H₃O⁺ is separated by dissociation of the ionic carbonate type polyurethane to increase the electrostatic repulsive force between homogeneous ions. As a result, the ionic carbonate type polyurethane is stretched in a straight line or maintained in a swelled state. Ultimately, when ionic binder, such as the ionic polyacrylic, the ionic carbonate type polyurethane, or the like, is added to the conductive polymer composition, the sheet resistance of the transparent electrode can be further lowered, in comparison with a binder according to the related art which increases the sheet resistance of the transparent electrode.

Meanwhile, the conductive polymer composition may further include one or more additives selected from a group consisting of a second dopant and a dispersion stabilizer.

Herein, the second dopant is a polar solvent for improving electrical conductivity of the conductive polymer composition, which may be at least one selected from a group consisting of dimethylsulfoxide, N-methylpyrrolidone, N,N-dimethylformamide and N-dimethylacetimide.

Also, ethylene glycol or sorbitol may be used as the dispersion stabilizer. The polar solvent as the second dopant is capable of improving electrical conductivity of the conductive polymer composition more highly when used together with the dispersion stabilizer than when used solely.

Besides, a binding agent, a surfactant, a defoamer, or the like may be further added to the conductive polymer composition.

Meanwhile, the conductive polymer composition according to the present invention may be completed by mixing the conductive polymer, the solvent, the ionic binder, the second dopant, and the dispersion stabilizer described above once every 10 minutes to 60 minutes at a room temperature during 30 minutes to 72 hours.

Conductive Film

A conductive film according to the present invention includes a base member, and a transparent electrode formed by coating and drying a conductive polymer composition on the base member. The conductive polymer composition includes a conductive polymer, a solvent, and an ionic binder. That is, the transparent electrode of the conductive film is formed by coating and drying the above described conductive polymer composition on the base member. Therefore, the description duplicated with the above description will be omitted or briefly mentioned.

The base member is for providing a region where the transparent electrode will be formed, and preferably, has a transparency in order to be employed in a display device. For example, the base member is preferably formed of polyethyleneterephthalate (PET), polycarbonate (PC), polymethylmethacrylate (PMMA), polyethylenenaphthalate (PEN), polyethersulfone (PES), cycloolefin copolymer (COC), triacetylcellulose (TAC) film, polyvinyl alcohol (PVA) film, polyimide (PI) film, polystyrene (PS), biaxially oriented polystyrene (K resin-containing biaxially oriented PS; BOPS), glass or tempered glass, etc., but not necessarily limited thereto. Meanwhile, it is preferable to perform high frequency treatment or primer treatment on the base member in order to improve the adhesive strength between the base member and the transparent electrode.

The transparent electrode is formed by coating and drying a conductive polymer composition on the base member. Herein, the conductive polymer composition includes a conductive polymer such as PEDOT/PSS, an ionic binder such as ionic polyacrylic or ionic carbonate type polyurethane, and a solvent. Herein, the solvent may be any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof. In addition, a second dopant or a dispersion stabilizer may be added to the conductive polymer composition. The second dopant may be at least one polar solvent selected from a group consisting of dimethylsulfoxide, N-methylpyrrolidone, N,N-dimethylformamide and N-dimethylacetimide. The dispersion stabilizer may be ethylene glycol or sorbitol.

Meanwhile, the conductive polymer composition may be coated on the base member by screen printing, gravure printing, or inkjet printing. The transparent electrode formed by coating and drying this conductive polymer composition on the base member has a low sheet resistance due to the added ionic binder. Eventually, the transparent electrode according to the present invention is capable of realizing a very low sheet resistance, 110Ω/□ to 500Ω/□, in comparison with a sheet resistance (10⁵Ω/□ to 10⁹Ω/□) of the transparent electrode according to the related art.

Hereinafter, although constitutions and effects of the present invention will be described with reference to preferred embodiments, the following preferred embodiments are merely for purpose of illustrating the present invention more clearly but has no intent to limit the present invention.

### Example

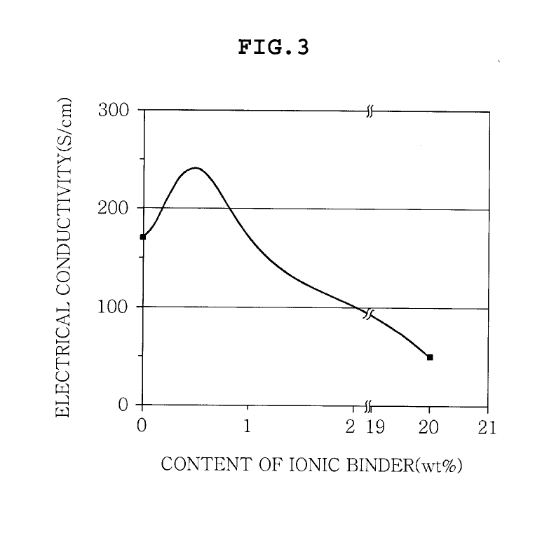

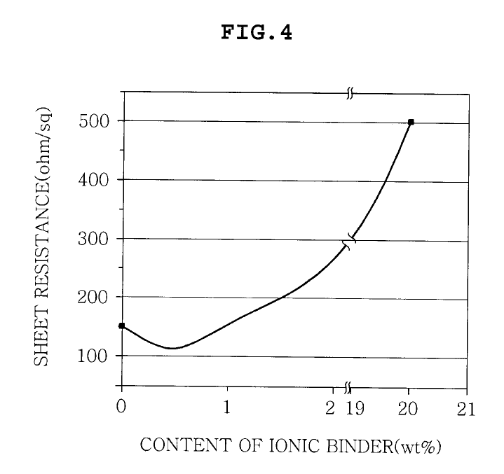

FIG. 3 is a graph showing electrical conductivity of a transparent electrode measured according to the content of ionic binder; and FIG. 4 is a graph showing a sheet resistance of a transparent electrode measured according to the content of ionic binder.

In the present example, the transparent electrode was formed by coating and drying a conductive polymer composition on a base member. The conductive polymer composition includes PEDOT/PSS, ionic polyacrylic, water, and dimethylsulfoxide. Herein, electrical conductivity and a sheet resistance of the transparent electrode were measured while the content of the ionic polyacrylic was adjusted.

Referring to FIG. 3, the transparent electrode has excellent electrical conductivity of 50 S/cm to 250 S/cm when the content of the ionic polyacrylic is 0.001 wt % to 20 wt %. Preferably, the transparent electrode has more excellent electrical conductivity of 100 S/cm to 250 S/cm when the content of the ionic polyacrylic is within 2 wt %.

Referring to FIG. 4, the transparent electrode has an excellent sheet resistance of 110Ω/□ to 500Ω/□ when the content of the ionic polyacrylic is 0.001 wt % to 20 wt %, similarly to the electrical conductivity. Preferably, the transparent electrode has a more excellent sheet resistance of 110Ω/□ to 250Ω/□ when the content of the ionic polyacrylic is within 2 wt %.

As described above, the sheet resistance of the transparent electrode according to the present example was decreased to 110Ω/□ to 500Ω/□ when the content of the ionic binder was 0.001 wt % to 20 wt %. Accordingly, the transparent electrode according to the present example is suitable for being used as a transparent electrode for a display device.

According to the present invention, the transparent electrode is formed by adding the ionic binder to the conductive polymer, thereby making it possible to have excellent flexibility and a low sheet resistance of 110Ω/□ to 500Ω/□ and simplify a coating process of the transparent electrode. Therefore, the transparent electrode according to the present invention is suitable for being used as a transparent electrode of a display device.

Although the preferred embodiments of the present invention have been disclosed for illustrative purposes, they are for specifically explaining the present invention and thus the conductive polymer composition and the conductive film using the same according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A conductive polymer composition, comprising:
a conductive polymer;
a solvent; and
an ionic binder.

2. The conductive polymer composition as set forth in claim 1, wherein the conductive polymer composition includes 15 wt % to 70 wt % of the conductive polymer, 20 wt % to 75 wt % of the solvent, and 0.001 wt % to 20 wt % of the ionic binder.

3. The conductive polymer composition as set forth in claim 1, wherein the conductive polymer is poly-3,4-ethylenedioxythiophene/polystylenesulfonate (PEDOT/PSS).

4. The conductive polymer composition as set forth in claim 1, wherein the solvent is any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof.

5. The conductive polymer composition as set forth in claim 1, wherein the ionic binder is ionic polyacrylic.

6. The conductive polymer composition as set forth in claim 1, wherein the ionic binder is ionic carbonate type polyurethane.

7. The conductive polymer composition as set forth in claim 1, further comprising one or more additives selected from a group consisting of a second dopant and a dispersion stabilizer.

8. The conductive polymer composition as set forth in claim 7, wherein the second dopant is at least one polar solvent selected from a group consisting of dimethylsulfoxide, N-methylpyrrolidone, N,N-dimethylformamide and N-dimethylacetimide.

9. The conductive polymer composition as set forth in claim 7, wherein the dispersion stabilizer is ethylene glycol or sorbitol.

10. A conductive film, comprising:
a base member; and
a transparent electrode formed by coating and drying a conductive polymer composition on the base member, the conductive polymer composition including a conductive polymer, a solvent, and an ionic binder.

11. The conductive film as set forth in claim 10, wherein the conductive polymer is poly-3,4-ethylenedioxythiophene/polystylenesulfonate (PEDOT/PSS).

12. The conductive film as set forth in claim 10, wherein the solvent is any one of aliphatic alcohol, aliphatic ketone, aliphatic carboxylic ester, aliphatic carboxylic acid amide, aromatic hydrocarbon, aliphatic hydrocarbon, acetonitrile, aliphatic sulfoxide, water, or a mixture thereof.

13. The conductive film as set forth in claim 10, wherein the ionic binder is ionic polyacrylic.

14. The conductive film as set forth in claim 10, wherein the ionic binder is ionic carbonate type polyurethane.

15. The conductive film as set forth in claim 10, wherein the conductive polymer composition further includes one or more additives selected from a group consisting of a second dopant and a dispersion stabilizer.

16. The conductive film as set forth in claim 15, wherein the second dopant is at least one polar solvent selected from a group consisting of dimethylsulfoxide, N-methylpyrrolidone, N,N-dimethylformamide and N-dimethylacetimide.

17. The conductive film as set forth in claim 15, wherein the dispersion stabilizer is ethylene glycol or sorbitol.

18. The conductive film as set forth in claim 10, wherein the transparent electrode has a sheet resistance of 110Ω/□ to 500Ω/□.

19. The conductive film as set forth in claim 10, wherein the conductive polymer composition is coated on the base member by screen printing, gravure printing, or inkjet printing.
